(19) United States
(12) Patent Application Publication
(10) Pub. No.: US 2022/0314312 A1
(43) Pub. Date: Oct. 6, 2022

(54) MOLDING CONDITION DERIVING DEVICE

(71) Applicant: SINTOKOGIO, LTD., Nagoya-shi (JP)

(72) Inventor: Yohei NOGUCHI, Nagoya-shi (JP)

(73) Assignee: SINTOKOGIO, LTD., Nagoya-shi (JP)

(21) Appl. No.: 17/704,269

(22) Filed: Mar. 25, 2022

(30) Foreign Application Priority Data
Mar. 31, 2021 (JP) 2021-060962

(51) Int. Cl. B22D 46/00; B22C 9/02; G06N 3/08; G06N 3/04

(52) U.S. Cl. CPC B22D 46/00; B22C 9/02; G06N 3/08; G06N 3/0454

(57) ABSTRACT

The present invention reasonably sets a molding condition of a mold for casting. A molding condition deriving device (i) collects a molding condition of a mold which molding condition excludes at least one molding condition, a sand property condition, and a quality condition of the mold, (ii) inputs the molding condition, the sand property condition, and the quality condition into a learned model learned with use of the molding condition, the sand property condition, and the quality condition, and (iii) derives the at least one molding condition.

This Nonprovisional application claims priority under 35 U.S.C. § 119 on Patent Application No. 2021-060962 filed in Japan on Mar. 31, 2021, the entire contents of which are hereby incorporated by reference.

### TECHNICAL FIELD

The present invention relates to a molding condition deriving device.

### BACKGROUND ART

A casting is manufactured by molding a mold first with use of foundry sand and then pouring molten metal into the mold. Thus, in order to manufacture a casting that satisfies a predetermined quality, it is necessary to consider not only a casting condition but also a molding condition of a mold. For example, Patent Literature 1 discloses a casting machine condition setting method in which (i) a casting condition and (ii) empirical knowledge about a defect and its cause are compiled in a knowledge base, an optimum casting condition is set by being inferred by an inference engine in accordance with an inputted initial condition, a state of a manufactured product is detected, and the casting condition is reset by another inference.

### CITATION LIST

### Patent Literature

### [Patent Literature 1]

Japanese Patent Application Publication Tokukaihei No. 05-008025

### SUMMARY OF INVENTION

### Technical Problem

Note, however, that the technique disclosed in Patent Literature 1 makes it possible to set a casting condition of a casting machine but makes it impossible to set a molding condition of a mold for casting.

An aspect of the present invention has an object to achieve a molding condition deriving device, a molding condition deriving method, a machine learning device, and a machine learning method each of which allows a molding condition of a mold for casting to be more reasonably set than the molding condition that is set by a user.

### Solution to Problem

In order to attain the object, a molding condition deriving device in accordance with an aspect of the present invention includes at least one processor configured to carry out: a collection step of collecting a molding condition of a mold which molding condition excludes at least one molding condition, a sand property condition that is a property of sand, which is a material of the mold, and a quality condition of the mold; and a deriving step of using a learned model learned by a dataset-for-learning to derive the at least one molding condition from the molding condition of the mold which molding condition excludes the at least one molding condition, the sand property condition that is a property of sand, which is a material of the mold, and the quality condition of the mold, the dataset-for-learning including the sand property condition, the molding condition, and the quality condition each for learning.

A molding condition deriving method in accordance with an aspect of the present invention includes: a collection step of collecting a molding condition of a mold which molding condition excludes at least one molding condition, a sand property condition that is a property of sand, which is a material of the mold, and a quality condition of the mold; and a deriving step of using a learned model learned by a dataset-for-learning to derive the at least one molding condition from the molding condition of the mold which molding condition excludes the at least one molding condition, the sand property condition that is a property of sand, which is a material of the mold, and the quality condition of the mold, the dataset-for-learning including the sand property condition, the molding condition, and the quality condition each for learning.

A machine learning device in accordance with an aspect of the present invention includes at least one processor configured to carry out the steps of: (a) constructing a dataset-for-learning; and (b) specifying, by a non-linear regression algorithm in which the dataset-for-learning is used, a non-linear function expression for computing at least one molding condition of a mold, or (c) constructing, by supervised learning in which the dataset-for-learning is used, a learned neural network model for estimating the at least one molding condition, the non-linear function expression or the learned neural network model having an input that is a molding condition of the mold which molding condition excludes the at least one molding condition, a sand property condition that is a property of sand, which is a material of the mold, and a quality condition of the mold, and the non-linear function expression or the learned neural network model having an output that is the at least one molding condition.

A machine learning method in accordance with an aspect of the present invention includes the steps of: (a) constructing a dataset-for-learning; and (b) specifying, by a non-linear regression algorithm in which the dataset-for-learning is used, a non-linear function expression for computing at least one molding condition of a mold, or (c) constructing, by supervised learning in which the dataset-for-learning is used, a learned neural network model for estimating the at least one molding condition, the non-linear function expression or the learned neural network model having an input that is a molding condition of the mold which molding condition excludes the at least one molding condition, a sand property condition that is a property of sand, which is a material of the mold, and a quality condition of the mold, and the non-linear function expression or the learned neural network model having an output that is the at least one molding condition.

### Advantageous Effects of Invention

An aspect of the present invention makes it possible to achieve a molding condition deriving device, a molding condition deriving method, a machine learning device, and a machine learning method each of which allows a molding condition of a mold for casting to be more reasonably set than the molding condition that is set by a user.

### BRIEF DESCRIPTION OF DRAWINGS

FIG. 1 is an overall configuration diagram of a molding condition computing system in accordance with Embodiment 1 of the present invention.

FIG. 2 is a block configuration diagram of a molding condition computing device in accordance with Embodiment 1.

FIG. 3 is a flowchart showing a molding condition computing method in accordance with Embodiment 1.

FIG. 4 is a flowchart showing a machine learning method in accordance with Embodiment 1.

FIG. 5 is a view illustrating a genetic algorithm.

FIG. 6 is a flowchart showing a flow of a relational expression specifying step carried out by the molding condition computing device.

FIG. 7 is a flowchart showing a flow of a process carried out by the molding condition computing device.

FIG. 8 is a view illustrating details of a crossover.

FIG. 9 is a view illustrating details of a subtree mutation.

FIG. 10 is a view illustrating details of a hoist mutation.

FIG. 11 is a view illustrating details of a point mutation.

FIG. 12 is an overall configuration diagram of a molding condition estimation system in accordance with Embodiment 2 of the present invention.

FIG. 13 is a block configuration diagram illustrating a configuration of a molding condition estimation device in accordance with Embodiment 2.

FIG. 14 is a flowchart showing a molding condition estimation method in accordance with Embodiment 2.

FIG. 15 is a flowchart showing a machine learning method in accordance with Embodiment 2.

### DESCRIPTION OF EMBODIMENTS

### Embodiment 1

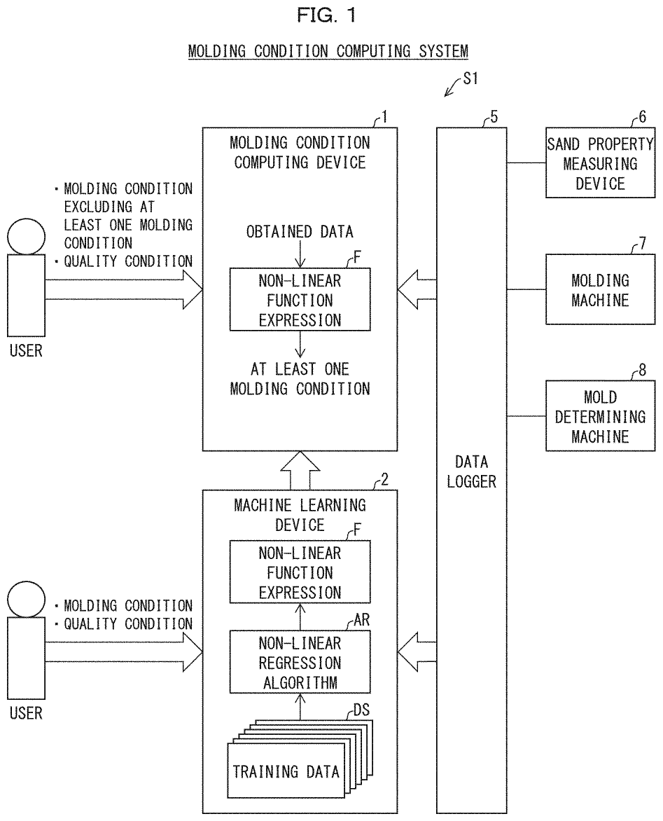

The following description will specifically discuss an embodiment of the present invention with reference to the drawings. FIG. 1 is an overall configuration diagram of a molding condition computing system S1 in accordance with Embodiment 1 of the present invention.

The molding condition computing system S1 is a system for computing and setting a molding condition of a mold (hereinafter simply referred to as a “molding condition”). As illustrated in FIG. 1, the molding condition computing system S1 includes a molding condition computing device 1 and a data logger 5. The molding condition computing system S1 can also include a machine learning device 2. The molding condition computing device 1 is an embodiment of a “molding condition deriving device” recited in Claims.

The mold is molded by a molding machine 7. The mold is molded by adding a binder-containing additive to foundry sand and mulling the foundry sand, filling a molding flask of the molding machine 7 with the mulled foundry sand, and compressing the mulled foundry sand. The binder is, for example, an inorganic material such as water glass. The mold to be molded is, for example, a master mold or a core.

An operating condition of a mold molding machine is changed in accordance with a property of sand, which is a material of the mold. Hereinafter, the operating condition of the mold molding machine is referred to as a molding condition, and a condition concerning a property of sand is referred to as a sand property condition. There are many types of molding conditions. In a case where one molding condition is changed, the other molding conditions also need to be changed. Thus, in order to mold a mold that satisfies a predetermined quality condition, it is necessary to appropriately combine a plurality of molding conditions in accordance with a plurality of sand property conditions. It is therefore not easy to find an optimum combination of a sand property condition and a molding condition for manufacturing a mold that satisfies a quality condition. Conventionally, a combination of molding conditions has been set by judgment based on an empirical rule of a skilled person. However, in Embodiment 1, the molding condition computing device 1 is used to set an optimum combination of a sand property condition and a molding condition for manufacturing a mold that satisfies a predetermined quality condition.

The sand property condition is at least one of compactability, a water content, air permeability, and a sand temperature. The compactability is a rate of decrease in volume as measured before and after compression that is carried out by applying a predetermined compressive force to sand. The water content is the proportion of water contained in sand, and can be determined by an amount of decrease in weight as measured in a case where the sand is heated and dried. The air permeability is ability to allow gas generated during pouring to be permeated (discharged to the outside). The sand temperature is the temperature of sand as measured before molding. These can be measured by, for example, a dedicated sand property measuring device.

The molding condition is at least one of a squeeze pressure, a board set position, a sand introduction time, an aeration pressure and/or a blow pressure during sand introduction (the aeration pressure and the blow pressure are herein collectively referred to as an “aeration condition”), a kind of single sided pattern plate (type), an amount of parting agent applied, and timing for operating a leveling frame.

The squeeze pressure is a pressure by which a squeeze board is forced after the molding flask has been filled with sand. The board set position is an initial position of the squeeze board into which the sand has not been introduced. The board set position changes an amount of sand to be introduced. The sand introduction time is a time for introducing sand. The aeration condition during sand introduction is a pressure of air that is supplied to uniformly fill the molding flask with the sand during introduction of the sand. The kind of single sided pattern plate is a kind of type that determines the shape of a mold (shape of a casting). The amount of parting agent applied is an amount of the parting agent to be applied to the single sided pattern plate. The timing for operating the leveling frame is timing for operating the leveling frame that is provided in a framed molding machine.

A quality condition (evaluation item for evaluating quality) of a molded mold is at least one of mold strength, the presence or absence of mold drop, and the presence or absence of sand adhesion. The mold strength is a pressure at which breakage such as deformation or crack does not occur in a case where the pressure is applied to the mold in a predetermined direction. Mold drop means that some of the mold peels off. Sand adhesion means that excess sand adheres to the mold. The mold strength is measured by, for example, a strength measuring machine. The presence or absence of mold drop and the presence or absence of sand adhesion are determined by, for example, a mold determining machine. Alternatively, these can be visually determined by an operator.

Regarding a quality evaluation, for example, the mold that has a strength not less than a predetermined value is evaluated as satisfying a predetermined quality. Alternatively, the mold that satisfies not only the mold strength but also the condition that mold drop in an amount not less than a predetermined amount does not occur and that no sand adhesion is observed can be evaluated as satisfying a predetermined quality.

The following description will discuss the molding condition computing device 1. The molding condition computing device 1 is a device for carrying out a molding condition computing method M1. The molding condition computing device 1 obtains sand property data (also referred to as the “sand property condition”) from the data logger 5. Specifically, the data logger 5 collects the sand property condition from the sand property measuring device 6, and provides the collected sand property condition to the molding condition computing device 1. In addition, the molding condition computing device 1 obtains, from the data logger 5, a molding condition excluding at least one molding condition (hereinafter, this may be referred to as a “derived molding condition”). Specifically, the data logger 5 collects, from the molding machine 7, the molding condition excluding the at least one molding condition, and provides the collected molding condition to the molding condition computing device 1. Alternatively, a user can directly input, into the molding condition computing device 1, the molding condition excluding the at least one molding condition. The quality condition is inputted by the user into the molding condition computing device 1. The data logger 5 can be composed of, for example, a programmable logic controller (PLC) and an industrial PC (IPC).

The molding condition computing device 1 computes the at least one molding condition (derived molding condition) with use of a relational expression (in Embodiment 1, a non-linear function expression) F specified by a non-linear regression algorithm LM in which a dataset-for-learning is used. Specifically, the molding condition computing device 1 computes the at least one molding condition by inputting, into the non-linear function expression F, (i) the sand property condition obtained from the data logger 5, (ii) the molding condition excluding the at least one molding condition, and (iii) the quality condition. In other words, the non-linear function expression has an input that is a molding condition of the mold which molding condition excludes the at least one molding condition, a property condition of sand, which is a material of the mold, and a quality condition of the mold, and the non-linear function expression F has an output that is the at least one molding condition. The non-linear function expression F is an embodiment of a “learned model” recited in Claims.

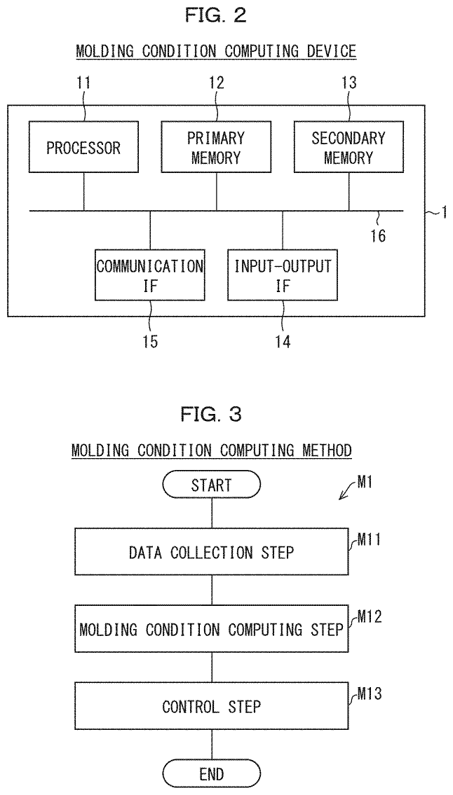

The following description will discuss a configuration of the molding condition computing device 1 with reference to FIG. 2. FIG. 2 is a block configuration diagram illustrating the configuration of the molding condition computing device 1 in accordance with Embodiment 1.

The molding condition computing device 1 is achieved by a general purpose computer, and includes a processor 11, a primary memory 12, a secondary memory 13, an input-output interface 14, a communication interface 15, and a bus 16. The processor 11, the primary memory 12, the secondary memory 13, the input-output interface 14, and the communication interface 15 are connected to one another through the bus 16.

In the secondary memory 13, a molding condition computing program P1, the non-linear function expression F, the sand property condition, molding data (also referred to as the “molding condition”), and quality data (also referred to as the “quality condition”) are stored. The processor 11 loads, in the primary memory 12, the molding condition computing program P1, the non-linear function expression F, the sand property condition, the molding condition, and the quality condition, which are stored in the secondary memory 13. Then, in accordance with instructions contained in the molding condition computing program P1 that has been loaded in the primary memory 12, the processor 11 carries out steps included in the molding condition computing method M1.

Examples of a device that can be used as the processor 11 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof.

Examples of a device that can be used as the primary memory 12 include a semiconductor random access memory (RAM). Examples of a device that can be used as the secondary memory 13 include a flash memory, a hard disk drive (HDD), a solid state drive (SSD), an optical disk drive (ODD), a floppy disk drive (FDD), and a combination thereof.

To the input-output interface 14, an input device(s) and/or an output device(s) is/are connected. Examples of the input-output interface 14 include interfaces such as Universal Serial Bus (USB), Advanced Technology Attachment (ATA), Small Computer System Interface (SCSI), and Peripheral Component Interconnect (PCI). Examples of the input device(s) that is/are connected to the input-output interface 14 include the data logger 5. Data obtained in the molding condition computing method M1 is inputted into the molding condition computing device 1 via the data logger 5 and stored in the primary memory 12.

To the communication interface 15, another computer is connected in a wired manner or wirelessly over a network. Examples of the communication interface 15 include interfaces such as Ethernet (registered trademark) and Wi-Fi (registered trademark).

Embodiment 1 employs a configuration in which a single processor (the processor 11) is used to carry out the molding condition computing method M1. Note, however, that the present invention is not limited to this. That is, it is alternatively possible to employ a configuration in which a plurality of processors are used to carry out the molding condition computing method M1 Examples of such a configuration include an aspect in which (i) a processor that is contained in a computer constituting a cloud server and (ii) a processor that is contained in a computer owned by a user of the cloud server cooperate with each other so as to carry out the molding condition computing method M1.

Embodiment 1 employs a configuration in which the sand property condition, the molding condition, or the quality condition is stored in a memory (the secondary memory 13) that is contained in the computer in which the processor (processor 11) that carries out the molding condition computing method M1 is contained. Note, however, that the present invention is not limited to this. That is, it is alternatively possible to employ a configuration in which the sand property condition, the molding condition, or the quality condition is stored in a memory that is contained in a computer different from the computer in which the processor that carries out the molding condition computing method M1 is contained.

Embodiment 1 employs a configuration in which the sand property condition, the molding condition, or the quality condition is stored in a single memory (the secondary memory 13). Note, however, that the present invention is not limited to this. That is, it is alternatively possible to employ a configuration in which the sand property condition, the molding condition, or the quality condition is divided and stored in a plurality of memories. In this case, a plurality of memories for storing the sand property condition, the molding condition, or the quality condition can be provided in a single computer (which can be or need not be a computer in which a processor that carries out the molding condition computing method M1 is contained), or can be divided and provided in a plurality of computers (which can or need not include a computer in which a processor that carries out the molding condition computing method M1 is contained). Examples of such a configuration include a configuration in which the sand property condition, the molding condition, or the quality condition is divided and stored in a memory contained in each of a plurality of computers constituting a cloud server.

The following description will discuss a flow of the molding condition computing method M1 carried out by the molding condition computing device 1. The molding condition computing method M1 is a method for computing the at least one molding condition from the sand property condition, the molding condition excluding the at least one molding condition, and the quality condition. The molding condition computing method is an embodiment of a “molding condition deriving method” recited in Claims.

FIG. 3 is a flowchart showing the molding condition computing method M1 in accordance with Embodiment 1. As shown in FIG. 3, the molding condition computing method M1 includes a data collection step M11 and a molding condition computing step M12. The molding condition computing method M1 can further include a control step M13 in which the processor 11 controls the molding machine 7 with use of the molding condition including the at least one molding condition that has been outputted from the non-linear function expression F. In that case, the molding condition computing device 1 also serves as a control device for controlling the molding machine 7. The molding condition including the at least one molding condition that has been outputted from the non-linear function expression F is, for example, a molding condition obtained by combining (i) a molding condition that has been outputted from the non-linear function expression F and (ii) a molding condition different from the outputted molding condition.

The data collection step M11 is a step in which the processor 11 of the molding condition computing device 1 obtains the sand property condition, the molding condition excluding the at least one molding condition, and the quality condition. Specifically, the processor 11 obtains the sand property condition from the data logger 5, obtains, from molding machine 7, the molding condition excluding the at least one molding condition, and obtains the quality condition from the input by the user.

The molding condition computing step M12 is a step in which the processor 11 uses the non-linear function expression F to compute one or more of molding conditions excluding a part of the molding conditions. The molding condition computing step M12 is an example of a “deriving step of deriving at least one molding condition of a mold” recited in Claims. In the molding condition computing step M12, the at least one molding condition is derived from a condition obtained by combining the molding condition excluding the at least one molding condition, the sand property condition, and the quality condition.

The following description will discuss at least one molding condition and a molding condition excluding the at least one molding condition. Previous experience has made it clear that a predetermined molding condition (at least one molding condition) significantly affects the quality of a mold in manufacturing the mold. The predetermined molding condition is, for example, at least one of a squeeze pressure, a board set position, and an aeration condition. This makes it important to determine, from (i) the molding condition excluding at least one of the squeeze pressure, the board set position, and the aeration condition and (ii) the sand property condition, at least one optimum molding condition that satisfies the quality condition.

Assume, for example, that the sand property condition is x (x1, x2, . . . , x1), the molding condition is y (y1, y2, . . . , ym), and the quality condition is z (z1, z2, . . . , zn). Assuming that a predetermined molding condition is y1 (e.g. a squeeze pressure), the molding condition excluding the predetermined molding condition is (m−1) molding conditions (y2, . . . , ym). The predetermined molding condition y1 is computed by inputting, into the function expression F, the sand property condition (x1, x2, . . . , x1), the molding condition excluding y1 (y2, . . . , ym), and the quality condition (z1, z2, . . . , zn). That is,

y1=F(x1,x2, . . . ,x1,y2, . . . ,ym,z1,z2, . . . ,zn)

A method for specifying the function expression F will be described later. Note that the number of predetermined molding conditions is not limited to one and can be two or more. In that case, the molding condition excluding the two or more molding conditions is inputted into the function expression F.

The control step M13 is a step in which the processor 11 controls the molding machine 7 with use of (i) the at least one computed molding condition and (ii) (a) the molding condition excluding the at least one molding condition and (b) the sand property condition, (a) the molding condition and (b) the sand property condition each having been obtained in the step M11. This step allows the molding machine 7 to mold the mold that satisfies the quality condition having been obtained in the step M11.

The above molding condition computing device 1 or the above molding condition computing method M1 makes it possible to use the non-linear function expression F to compute and set an optimum molding condition of a mold for casting. This allows a molding condition of a mold for casting to be more reasonably set than the molding condition that is set by a user.

In the embodiment described above, data that is inputted into the non-linear function expression F is the sand property condition, the molding condition excluding the at least one molding condition, and the quality condition. However, the content of the data is not limited to this. For example, an input into the non-linear function expression F can include a quality condition of a casting to be manufactured with use of a mold. The quality condition of the casting is at least one of the strength of the casting and the presence or absence of a defect (such as a “cavity”).

The quality of a mold is directly related to the quality of a casting to be cast. Thus, basically, the quality of the casting is also controlled by controlling the quality of the mold. However, by adding, to data to be used to determine a molding condition of a mold, the quality of a casting to be manufactured in the mold, it is possible to set the molding condition of the mold with higher accuracy.

The following description will discuss the machine learning device 2 in accordance with Embodiment 1. The machine learning device 2 obtains a dataset of the sand property condition, the molding condition, and the quality condition as a dataset-for-learning DS, and specifies, in accordance with the dataset-for-learning DS, a relational expression among the sand property condition, the molding condition, and the quality condition.

The machine learning device 2 is configured to carry out a machine learning method M2. As illustrated in FIG. 1, the machine learning device 2 obtains the sand property condition, the molding condition, and the quality condition from the data logger 5 when a mold is actually manufactured. Specifically, the data logger 5 prepares the dataset-for-learning DS by collecting the sand property condition from the sand property measuring device 6, obtaining the molding condition from the molding machine 7, and obtaining the quality condition from the mold determining machine 8. The machine learning device 2 can obtain at least one of the sand property condition, the molding condition, and the quality condition from the user.

The data logger 5 provides the sand property condition, the molding condition, and the quality condition, which have been thus collected, to the machine learning device 2 for learning. The machine learning device 2 inputs, into the non-linear regression algorithm AR, the dataset-for-learning DS including the sand property condition, the molding condition, and the quality condition, which have been thus obtained, so as to specify the non-linear function expression F.

Alternatively, the user can collect the sand property condition, the molding condition, and the quality condition which have been recorded when a mold was manufactured in the past, and input those conditions, as the dataset-for-learning DS, into the machine learning device 2. In a case where only data obtained when a mold is newly manufactured is used, it takes time to increase the number of datasets-for-learning DS so as to increase accuracy of the non-linear function expression F. However, the dataset-for-learning DS that includes a dataset obtained when a mold was manufactured in the past allows the non-linear function expression F to be more accurate.

In Embodiment 1, the machine learning device 2 also serves as the molding condition computing device 1. That is, the machine learning device 2 is configured by the processor 11, the primary memory 12, the secondary memory 13, the input-output interface 14, the communication interface 15, and the bus 16, which have been described in the molding condition computing device 1. The following description is based on that premise. Note, however, that the machine learning device 2 can be alternatively configured by a different computer that is capable of communicating information with the molding condition computing device 1.

The secondary memory 13 stores a machine learning program P2 and the dataset-for-learning DS. The dataset-for-learning DS is a set of training data DS1, DS2 . . . . The processor 11 has a function similar to that described earlier. The dataset-for-learning DS that is stored in the secondary memory 13 is constructed in a dataset-for-learning construction step M21 (described later) of the machine learning method M2, and used in a relational expression specifying step M22 (described later) of the machine learning method M2. A relational expression F that has been specified in the relational expression specifying step M22 of the machine learning method M2 is also stored in the secondary memory 13.

Data that is obtained from the user in the machine learning method M2 is inputted into the machine learning device 2 via the input device(s) and stored in the primary memory 12. Information that is provided to the user in the machine learning method M2 is outputted from the machine learning device 2 via the output device(s). In a case where the machine learning device 2 is configured as a computer that is separate from the molding condition computing device 1, data (e.g., the non-linear function expression F) to be provided to the molding condition computing device 1 can be transmitted and received via a network.

The following description will discuss a flow of the machine learning method M2. The machine learning method M2 is a method for using an algorithm (in Embodiment 1, the non-linear regression algorithm AR) to specify, in accordance with the sand property condition, the molding condition, and the quality condition, the relational expression F among these conditions. In Embodiment 1, a genetic algorithm is used as the non-linear regression algorithm AR. However, the present invention is not limited to this. For example, a non-linear regression algorithm different from the genetic algorithm, such as logistic regression can be alternatively be used.

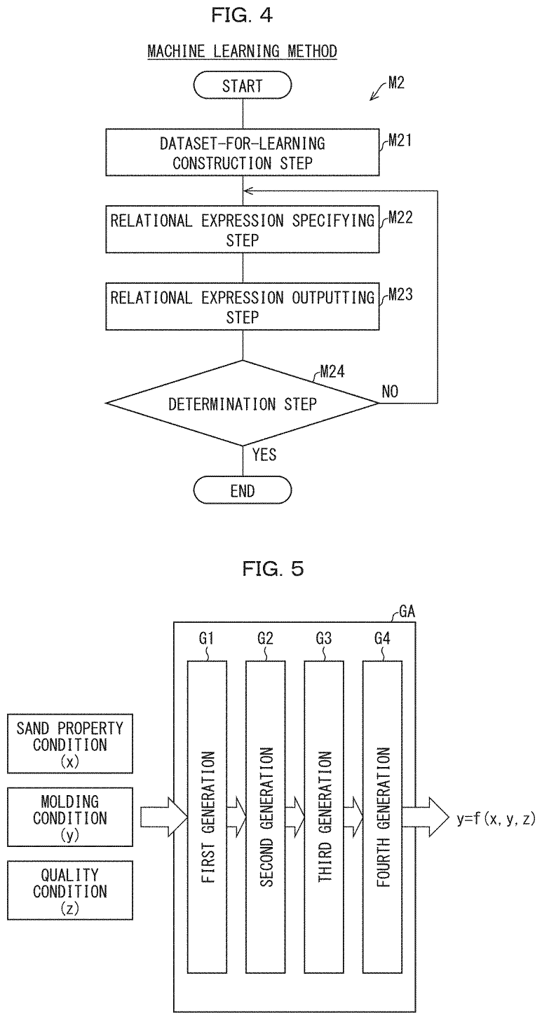

FIG. 4 is a flowchart showing the machine learning method M2 in accordance with Embodiment 1. The machine learning method M2 includes the dataset-for-learning construction step M21, the relational expression specifying step M22, a relational expression outputting step M23, and a determination step M24.

The dataset-for-learning construction step M21 is a step in which the processor 11 constructs the dataset-for-learning DS, which is a set of training data DS1, DS2 . . . .

Each training data DSi (i=1, 2, . . . ) includes the sand property condition, the molding condition, and the quality condition. The sand property condition, the molding condition, and the quality condition that are included in the training data DSi are data similar to the sand property condition, the molding condition, and the quality condition that are inputted into the non-linear function expression F by the molding condition computing device 1. In the dataset-for-learning construction step M21, the processor 11 obtains these pieces of data from the data logger 5 and constructs the dataset-for-learning DS. The constructed dataset-for-learning DS is stored in the secondary memory 13.

The relational expression specifying step M22 is a step in which the processor 11 specifies, by a non-linear regression algorithm in which the dataset-for-learning is used, a non-linear function expression for computing at least one molding condition of a mold. Specifically, in the relational expression specifying step M22, the processor 11 refers to the dataset-for-learning DS including the sand property condition x1, x2, . . . , x1, the molding condition y1, y2, . . . , ym, and the quality condition z1, z2, . . . , zn, and uses the non-linear regression algorithm to specify the non-linear function expression representing a relationship among the conditions x, y, and z. In Embodiment 1, the processor 11 uses the genetic algorithm to specify the relational expression.

In the relational expression specifying step M22, for example, a relationship is specified between (a) a combination of the sand property condition, the molding condition of the mold which molding condition excludes the at least one molding condition, and the quality condition and (b) the at least one molding condition. In order to specify the relational expression for outputting the at least one molding condition, the user inputs, into the processor 11, the molding condition of the mold which molding condition excludes the at least one molding condition, the sand property condition, and the quality condition.

For example, the relational expression for outputting the squeeze pressure is preferably specified in a case where the molding condition excluding the squeeze pressure, the sand property condition, and the quality condition are inputted into the processor 11. Alternatively, for example, the relational expression for outputting the board set position is preferably specified in a case where the molding condition excluding the board set position, the sand property condition, and the quality condition are inputted into the processor 11. Alternatively, for example, the relational expression for outputting the aeration condition is preferably specified in a case where the molding condition excluding the aeration condition, the sand property condition, and the quality condition are inputted into the processor 11. Alternatively, the relational expression for outputting two or three excluded conditions is preferably specified in a case where a dataset including the molding condition excluding two or three of the squeeze pressure, the board set position, and the aeration condition is inputted into the processor 11.

The relational expression outputting step M23 is a step in which the processor 11 outputs the relational expression specified in the relational expression specifying step M22. In Embodiment 1, the processor 11 outputs (displays) the relational expression on a display. In this case, the processor 11 can display, on the display, a graph showing the relational expression.

The user who visually observes the relational expression that has been outputted to the display determines whether the relational expression specified by the molding condition computing device 1 is an appropriate relational expression. Then, the user who has finished the determination carries out a user operation for inputting a determination result into the machine learning device 2.

The determination step M24 is a step in which the processor 11 determines, in accordance with the user operation described above, whether the relational expression specified in the relational expression specifying step M22 is an appropriate relational expression. In a case where it is determined in the determination step M24 that the relational expression specified in the relational expression specifying step M22 “is an appropriate relational expression”, the processor 11 stores the specified relational expression F in the secondary memory 13. In contrast, in a case where it is determined in the determination step M24 that the relational expression specified in the relational expression specifying step M22 “is not an appropriate relational expression”, the processor 11 carries out again the relational expression specifying step M22 (described earlier) and subsequent processes. Note that the processor 11 that carries out again the relational expression specifying step M22 and the subsequent processes can carry out a process for changing a set of the sand property condition, the molding condition, and the quality condition that are used in the relational expression specifying step M22, and/or changing a parameter used in the genetic algorithm.

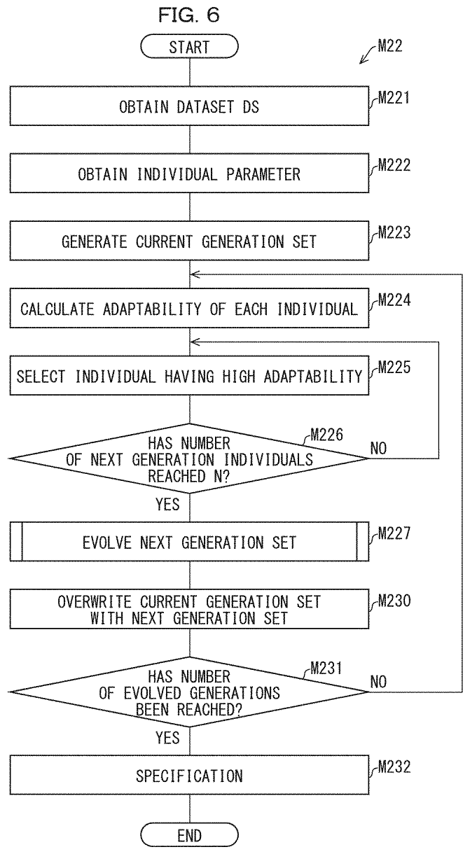

The following description will discuss, with reference to FIGS. 5 and 6, a specific example of the relational expression specifying step M22 included in the machine learning method M2. FIG. 5 is a view illustrating a genetic algorithm GA. FIG. 6 is a flowchart illustrating a flow of the relational expression specifying step M22 carried out by the processor 11. In the example of FIG. 5, the genetic algorithm GA includes a first generation G1 to a fourth generation G4.

In the relational expression specifying step M22 in accordance with the present specific example, the genetic algorithm is used to specify the non-linear function expression representing the relationship among the conditions x, y, and z. Note here that the genetic algorithm refers to an algorithm for searching for a solution by preparing a plurality of individuals i in which candidates for the solution are expressed by genes, preferentially selecting an individual i having high adaptability Di, and repeatedly carrying out operations such as crossing-over and mutation. In Embodiment 1, the individual i is obtained by representing a non-linear relational expression by a tree structure, and an operator and an argument that are included in the relational expression is represented by a node of a tree. The adaptability Di is given by an adaptability function.

The processor 11 uses a predetermined module (hereinafter referred to as an “A module”) to carry out the relational expression specifying step M22. The A module is a module that carries out the genetic algorithm. In the A module, in order to predict new data, first, the processor 11 starts with preparation of a simple random population representing a relationship between known independent variables and their dependent variable targets. Next, by selecting the most appropriate individual from a group to be subjected to gene manipulation, the processor 11 evolves the group so as to generate a next generation group. The above operation specifies a relational expression that best shows the above relationship.

In the present specific example, a module that carries out genetic programming is used as the A module. Genetic programming is extension of the genetic algorithm and uses a tree structure as an expression of a genotype. The flow of the relational expression specifying step M22 of FIG. 6 is shown as an example, and a method for specifying the relational expression with use of the genetic algorithm GA is not limited to the method illustrated in FIG. 6. The method for specifying the relational expression with use of the genetic algorithm GA can be any of other various methods.

In a step M221, the processor 11 obtains the dataset DS. In the present operation example, the processor 11 obtains the sand property data, the molding data, and the quality data by reading the dataset DS stored in the secondary memory 13.

In a step M222, the processor 11 obtains a parameter for use in the genetic algorithm GA (hereinafter referred to as an “individual parameter”). The individual parameter includes, for example, the number N of generated individuals, a tournament size Nt, a crossing-over probability Pc, a mutation probability Pms, the number Ng of evolved generations, an operator Oj for use in a syntactic tree, a maximum depth d of the syntactic tree, and event occurrence probabilities Pk1 to Pk5. For example, the user inputs a value of each individual parameter into the molding condition computing device 1.

The number N of generated individuals represents the number of individuals i to be included in a set. The tournament size Nt is the number of individuals i that are randomly selected from a current generation set. The mutation probability Pms is a probability with which a gene is mutated. Examples of the operator Oi for use in a syntactic tree include Max, Min, sqrt (a root), log (a natural logarithm), +, −, ×, /, sin (a radian), cos (a radian), tan (a radian), abs, neg, and inv. Max is an operator that selects a maximum value. Min is an operator that selects a minimum value. neg is an operator that causes a sign to be minus. inv is an operator that causes an argument close to zero to be 0.

The event occurrence probabilities Pk1 to Pk5 are probabilities with which respective operations m1 to m5 are selected as operations to evolve a next generation set. The processor 11 evolves the next generation set by any method among the operations m1 to m5. It is assumed that the sum total of the event occurrence probabilities Pk1 to Pk5 is 1. For example, the event occurrence probabilities Pk1, Pk2, Pk3, Pk4, and Pk5 have values that are “0.1”, “0.2”, “0.3”, “0.3”, and “0.1”, respectively. The operations m1 to m5 will be described later with reference to another drawing.

In a step M223, in accordance with specified individual parameters (the operator Oi for use in a syntactic tree, the maximum depth d of the syntactic tree, etc.), the processor 11 randomly generates N individuals i and generates a set of N individuals i to be a first current generation.

In a step M224, the processor 11 calculates the adaptability Di of each of the individuals i included in the current generation set. The adaptability Di is given by the adaptability function.

In a step M225, the processor 11 randomly extracts, from the current generation set, individuals i whose number is the tournament size Nt, selects, among the individuals i, an individual i having the highest adaptability Di, and adds the selected individual i to the next generation set. The individual i selected in the step M225, that is, the individual i added to the next generation set is also referred to as a “winner tree”.

The processor 11 repeatedly carries out the process in the step M225 until the number of next generation individuals reaches N, which is identical to the number of current generation individuals, that is, while the number of next generation individuals does not reach N (No in a step M226). When the number of next generation individuals reaches N (YES in the step M226), the processor 11 carries out the process in a step M227.

In the step M227, the processor 11 carries out the process for evolving the next generation set. Note that the step M227 will be described in detail later with reference to another drawing.

In a step M230, the processor 11 overwrites the current generation set with the next generation set. In a step M231, the processor 11 determines whether the number Ng of evolved generations has been reached. In a case where the number Ng of evolved generations has not been reached (NO in the step M231), the processor 11 returns to the process in the step M224. In contrast, in a case where the number Ng of evolved generations has been reached (YES in the step M231), the processor 11 proceeds to the process in a step M232.

In the step M232, the processor 11 specifies, from among the individuals i included in the current generation set, the individual i having the highest adaptability Di. Through the above processes, the processor 11 specifies a non-linear relational expression representing a relationship among the sand property data, the molding data, and the quality data.

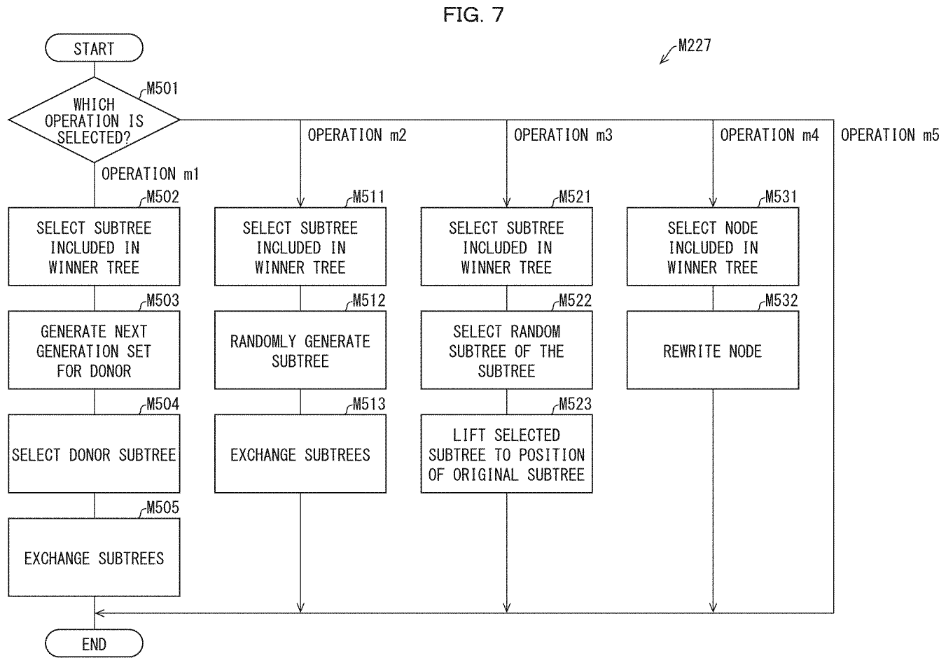

FIG. 7 is a flowchart illustrating a flow of the step M227 carried out by the processor 11. In a step M501, the processor 11 selects one of the operations m1 to m5 in accordance with the event occurrence probabilities Pk1 to Pk5 that have been set by the user. In a case where the operation m1 is selected (“OPERATION m1” in the step M501), the processor 11 proceeds to the process in a step M502. In a case where the operation m2 is selected (“OPERATION m2” in the step M501), the processor 11 proceeds to the process in a step M511. In a case where the operation m3 is selected (“OPERATION m3” in the step M501), the processor 11 proceeds to the process in a step M521. In a case where the operation m4 is selected (“OPERATION m4” in the step M501), the processor 11 proceeds to the process in a step M531. In a case where the operation m5 is selected (“OPERATION m5” in the step M501), the processor 11 ends the process.

The operation m1 is a crossover. The crossover is a method for mixing genetic materials between individuals. In the case of the crossover, in the step M502, the processor 11 randomly selects a subtree included in each winner tree that is included in the next generation set.

In a step M503, the processor 11 generates the next generation set for a donor. Details of the process in the step M503 are similar to those in the steps M223 to M225 in FIG. 6. That is, first, the processor 11 randomly generates N individuals i in accordance with the individual parameter specified by the user, and generates a set of N individuals i (hereinafter referred to as a “donor set”). Next, the processor 11 calculates the adaptability Di of each of the individuals i included in the donor set. Subsequently, the processor 11 randomly extracts, from the donor set, individuals i whose number is the tournament size Nt, selects, among the individuals i, an individual i having the highest adaptability Di, and adds the selected individual i to a next generation donor set. The individual i selected through this process is also referred to as a “donor tree”. The processor 11 repeatedly carries out a process for selecting the donor tree until the number of next generation donor trees reaches N.

In a step M504, the processor 11 randomly selects a subtree included in the donor tree (hereinafter referred to as a “donor subtree”).

In a step M505, the processor 11 exchanges subtrees in the winner tree. In Embodiment 1, the processor 11 removes, from the winner tree, the subtree selected in the step M502, and implants, in a place where the subtree was present, the donor subtree selected in the step M503. That is, the processor 11 replaces the subtree included in the winner tree with the donor subtree. The winner tree in which the subtree has been thus replaced serves as a next generation descendant (individual).

The operation m2 is an operation to mutate the subtree. A mutation in the subtree makes it possible to maintain diversity by reintroducing, into a group, a function and an operator that have been lost. In this case, in the step M511, the processor 11 randomly selects the subtree included in the winner tree.

In a step M512, the processor 11 randomly generates a subtree. In a step M513, the processor 11 exchanges subtrees in the winner tree. In Embodiment 1, the processor 11 removes, from the winner tree, the subtree selected in the step M511, and implants, in a place where the subtree was present, the subtree generated in the step M512. That is, the processor 11 replaces the subtree included in the winner tree with the subtree generated in the step M512. The winner tree in which the subtree has been thus replaced serves as a next generation descendant (individual).

The operation m3 is a hoist mutation. The hoist mutation is a mutation operation to combat tree swelling. In the step M521, the processor 11 randomly selects the subtree included in the winner tree. In a step M522, the processor 11 randomly selects a subtree included in the subtree selected in the step M521.

In a step M523, the processor 11 lifts, to a position of the original subtree (subtree selected in the step M521), the subtree selected in the step M522. The winner tree in which the subtree has been thus lifted serves as a next generation descendant (individual).

The operation m4 is a point mutation. The point mutation is an operation to reintroduce, into a group, a relational expression and an operator that have been lost, in order to maintain diversity. In a step M531, the processor 11 randomly selects a node of the winner tree. In a step M532, the processor 11 replaces, with another node, the node selected in the step M531. This replaces a relational expression represented by the winner tree with another relational expression that requires arguments whose number is the same as the number of arguments of the original node. The winner tree to be obtained by the replacement serves as a next generation descendant (individual).

The operation m5 is regeneration. In this case, the winner tree is duplicated and included in the next generation without being modified.

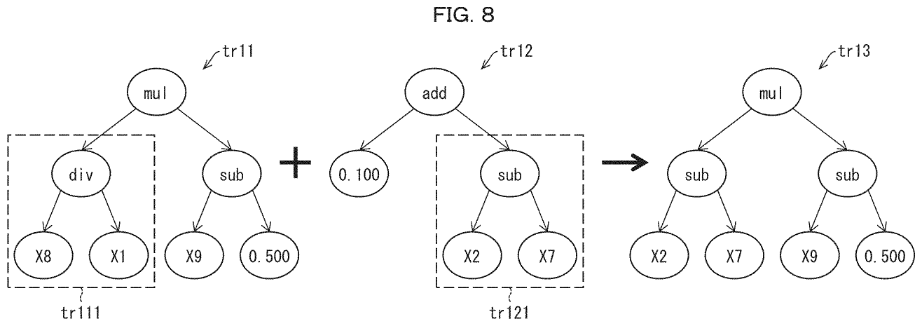

FIGS. 8 to 11 are views each illustrating details of operations carried out with respect to the winner tree. FIG. 8 is a view illustrating details of the operation m1 (crossover). In the example of FIG. 8, a subtree trill of a winner tree tr11 is replaced with a subtree tr121 of a donor tree tr12, so that a winner tree tr13 is obtained. The winner tree tr13 serves as a next generation descendant (individual).

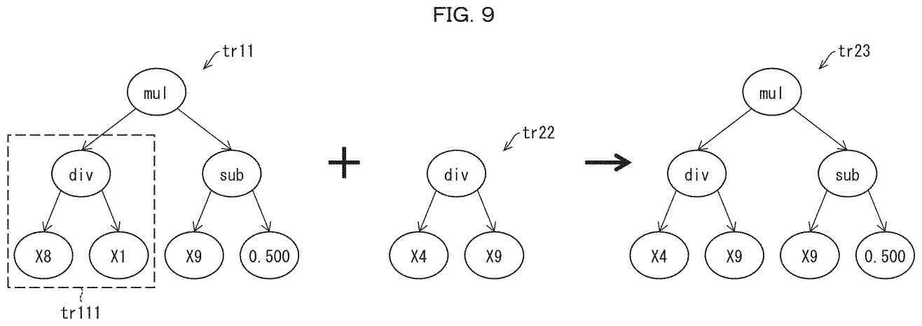

FIG. 9 is a view illustrating details of the operation m2 (subtree mutation). In the example of FIG. 9, the subtree tr111 of the winner tree tr11 is replaced with a subtree tr22, so that a winner tree tr23 is obtained. The winner tree tr23 serves as a next generation descendant (individual).

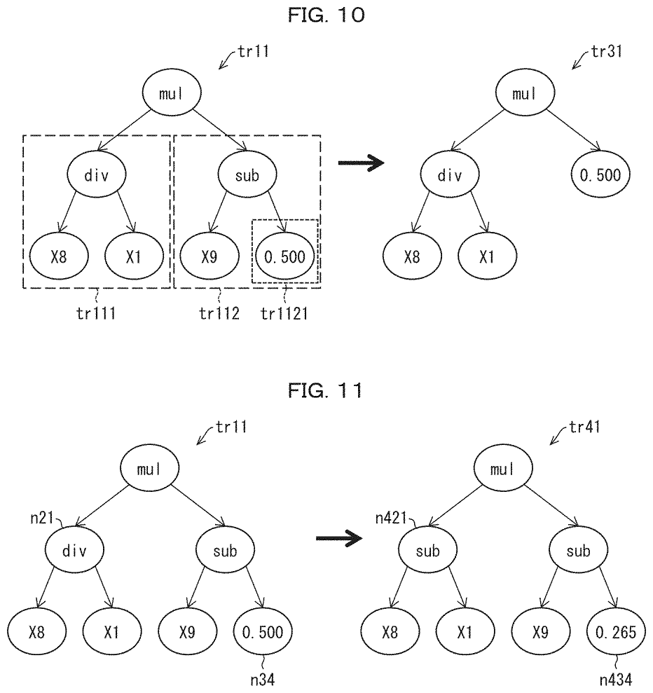

FIG. 10 is a view illustrating details of the operation m3 (hoist mutation). In the example of FIG. 10, a subtree tr1121 of the winner tree tr11 is lifted to a position of a subtree tr112, so that a winner tree tr31 is obtained. The winner tree tr31 serves as a next generation descendant (individual).

FIG. 11 is a view illustrating details of the operation m4 (point mutation). In the example of FIG. 11, a node n21 and a node n34 that are included in the winner tree tr11 are replaced with a node n421 and a node n434, respectively, so that a winner tree tr41 is obtained. The winner tree tr41 serves as a next generation descendant (individual).

According to the above machine learning device 2 and the above machine learning method M2, the machine learning device 2 can specify, by the non-linear regression algorithm, the relational expression (non-linear function expression) that allows the molding condition to be reasonably derived.

In Embodiment 1 described earlier, the dataset that is obtained by the machine learning device 2 is composed of the sand property condition, the molding condition, and the quality condition. However, the content of the dataset is not limited to this. For example, it is possible to add, to the dataset to be inputted into the non-linear function expression F, a quality condition of a casting that has been manufactured with use of a mold.

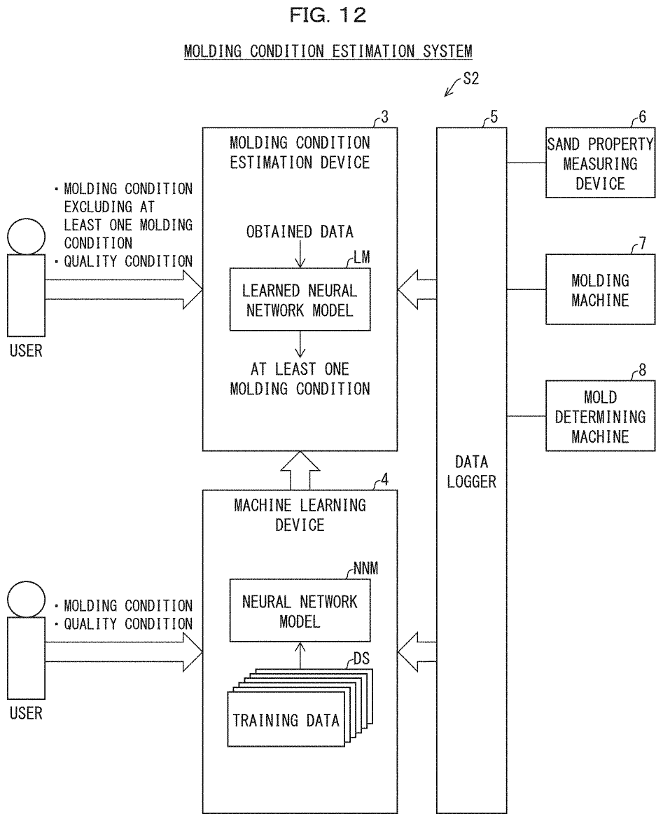

The following description will discuss another embodiment of the present invention with reference to the drawings. Note that for convenience, members having functions identical to those of the respective members described in Embodiment 1 are given respective identical reference numerals, and a description of those members is omitted. FIG. 12 is an overall configuration diagram of a molding condition estimation system S2 in accordance with Embodiment 2 of the present invention.

The molding condition estimation system S2 is a system for estimating and setting a molding condition of a mold. As illustrated in FIG. 12, the molding condition estimation system S2 includes a molding condition estimation device 3 and a data logger 5. The molding condition estimation system S2 can also include a machine learning device 4. The molding condition estimation device 3 is an embodiment of a “molding condition deriving device” recited in Claims.

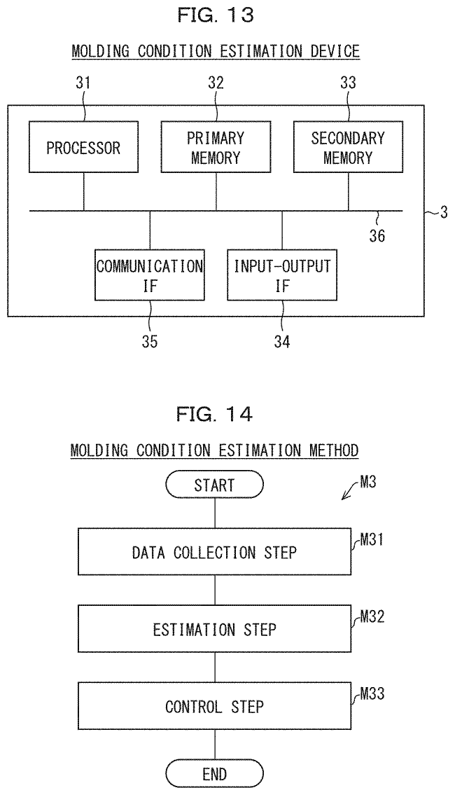

The following description will discuss the molding condition estimation device 3. In the molding condition estimation device 3, a learned neural network model LM (learned model) is used instead of the non-linear function expression F. As illustrated in FIG. 13, a processor 31, a primary memory 32, a secondary memory 33, an input-output IF 34, a communication IF 35, and a bus 36 correspond to the processor 11, the primary memory 12, the secondary memory 13, the input-output IF 14, the communication IF 15, and the bus 16, respectively.

FIG. 14 is a flowchart showing a molding condition estimation method (molding condition deriving method) M3 in accordance with Embodiment 2. As shown in FIG. 14, the molding condition estimation method M3 includes a data collection step M31 and an estimation step M32. The molding condition estimation method M3 can further include a control step M33 in which the processor 31 controls a molding machine 7 with use of an estimated molding condition and a previously obtained molding condition. In that case, the molding condition estimation device 3 also serves as a control device for controlling the molding machine 7.

The data collection step M31 is a step in which the processor 31 obtains a sand property condition, a molding condition of a mold which molding condition excludes at least one molding condition, and a quality condition. The data collection step M31 is similar to the data collection step M11 described in Embodiment 1.

The estimation step M32 is a step in which the processor 31 uses the learned neural network model LM to estimate the at least one molding condition. The estimation step M32 is an example of a “deriving step of deriving a molding condition” recited in Claims. In the estimation step M32, for example, from a condition obtained by combining the molding condition of the mold which molding condition excludes the at least one molding condition, the sand property condition, and the quality condition, the at least one molding condition is derived that satisfies the quality condition.

For example, the learned neural network model LM has an input that is a molding condition of the mold which molding condition excludes the at least one molding condition, a property condition of sand, which is a material of the mold, and a quality condition of the mold, and the learned neural network model LM has an output that is the at least one molding condition.

The control step M33 is a step in which the processor 31 controls the molding machine 7 with use of (i) the derived molding condition and (ii) the molding condition and the sand property condition each having been obtained in the step M31. This step allows the molding machine 7 to mold the mold that satisfies the quality condition having been obtained in the step M31.

The following description will discuss the machine learning device 4 in accordance with Embodiment 2. In the machine learning device 4, a dataset-for-learning DS instead of the non-linear regression algorithm AR is inputted into a neural network model NNM, and the learned neural network model LM is generated instead of the non-linear regression equation F.

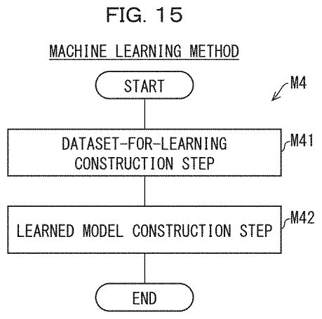

FIG. 15 is a flowchart showing a machine learning method M4 in accordance with Embodiment 2. The machine learning method M4 includes a dataset-for-learning construction step M41 and a learned model construction step M42. The dataset-for-learning construction step M41 is a step in which the processor 31 constructs the dataset-for-learning DS, which is a set of training data DS1, DS2 . . . .

The learned model construction step M42 is a step in which the processor 31 constructs, by supervised learning in which a dataset-for-learning is used, a learned neural network model for estimating at least one molding condition. Specifically, in the learned model construction step M42, the processor 31 constructs the learned neural network model LM by inputting the dataset-for-learning DS into the neural network model NNM. More specifically, the processor 31 inputs, for example, the sand property condition, the molding condition of the mold which molding condition excludes the at least one molding condition, and the quality condition, and subjects the neural network model NNM to learning for outputting the at least one molding condition.

Matters described in Variations 1 and 2 of Embodiment 1 are also applicable to Embodiment 2. That is, a quality condition of a casting that has been cast with use of a mold can be added to the input into the learned neural network model (or the learned model) LM.

Furthermore, Embodiment 1 has described a configuration in which a non-linear regression algorithm (specifically, a genetic algorithm) is used to construct a function expression by which a certain molding condition of a mold is derived from another molding condition of the mold, a property condition of sand, and a quality condition of the mold. However, a method for constructing a relational expression is not limited to the non-linear regression algorithm. For example, a Monte Carlo method can be used to construct the function expression. In this case, for example, a plurality of function expressions are prepared by randomly selecting the length of the function expression and an element(s) (such as a variable and/or an operator) of the function expression, and the function expression by which a certain molding condition of a mold is derived from another molding condition of the mold, a property condition of sand, and a quality condition of the mold is constructed by selecting, from among these function expressions, a function expression that has the smallest error.

Moreover, Embodiment 1, 2 has described a configuration in which a learned model (specifically, a function expression or a neural network) is used to derive a certain molding condition of a mold from another molding condition of the mold, a property condition of sand, and a quality condition of the mold. However, the present invention is not limited to this. For example, a certain molding condition of a mold can be derived from another molding condition of the mold, a property condition of sand, and a quality condition of the mold with reference to a table in which the certain molding condition of the mold is associated with the another molding condition of the mold, the property condition of sand, and the quality condition of the mold.

Further, for example, the data collection step M11, M31, the molding condition computing step M12, the control step M13, M33, the dataset-for-learning construction step M21, the relational expression specifying step M22, the relational expression outputting step M23, the determination step M24, the estimation step M32, the dataset-for-learning construction step M41, and the learned model construction step M42 can be implemented by respective separate logic circuits such as an FPGA (Field Programmable Gate Array).

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Molding condition computing device
2, 4 Machine learning device
3 Molding condition estimation device
5 Data logger
6 Sand property measuring device
7 Molding machine
8 Mold determining machine
11, 31 Processor
12, 32 Primary memory
13, 33 Secondary memory
14, 34 Input-output IF
15, 35 Communication IF
16, 36 Bus

1. A molding condition deriving device for deriving a mold molding condition, said molding condition deriving device comprising:
at least one processor; and
a primary memory connected to the at least one processor,
the at least one processor being configured to carry out:
a collection step of collecting a molding condition of a mold which molding condition excludes at least one molding condition, a sand property condition that is a property of sand, which is a material of the mold, and a quality condition of the mold; and
a deriving step of using a learned model learned by a dataset-for-learning to derive the at least one molding condition from the molding condition of the mold which molding condition excludes the at least one molding condition, the sand property condition that is a property of sand, which is a material of the mold, and the quality condition of the mold,
the dataset-for-learning including the sand property condition, the molding condition, and the quality condition each for learning.

2. The molding condition deriving device as set forth in claim 1, wherein the learned model is (i) a non-linear function expression specified by a non-linear regression algorithm in which the dataset-for-learning is used or (ii) a learned neural network model that has been constructed by supervised learning in which the dataset-for-learning is used.

3. The molding condition deriving device as set forth in claim 1, wherein the at least one molding condition is derived in further consideration of a quality condition of a casting to be manufactured with use of the mold.

4. The molding condition deriving device as set forth in claim 1, wherein the at least one processor controls a molding machine with use of the molding condition including the at least one molding condition having been outputted from the learned model.
